(19) United States
(12) Patent Application Publication
(10) Pub. No.: US 2012/0079663 A1
(43) Pub. Date: Apr. 5, 2012

(54) COAXIAL CABLE CONNECTOR INSTALLATION TOOL

(75) Inventors: Matt Willard, Olive Branch, MS (US); Paul Bartholomew, Somerville, TN (US); Mathieu Turpault, Berwyn, PA (US)

(73) Assignee: THOMAS & BETTS INTERNATIONAL, INC., Wilmington, DE (US)

(21) Appl. No.: 12/895,562

(22) Filed: Sep. 30, 2010

(51) Int. Cl. H02G 1/12; B25F 1/00; H01R 43/00

(52) U.S. Cl. 7/107; 81/9.4; 29/750; 30/90.1

(57) ABSTRACT

An improved coaxial cable stripper and crimper tool is disclosed. The cable stripper includes a unique mechanism to release scrap portions of cable jacket that get stuck in between the dual-level cable stripping blades.

### FIELD OF THE INVENTION

The present invention is generally directed toward a cable crimping and stripping device which has the capacity to eject scrap material from between the stripping blades.

### BACKGROUND OF THE INVENTION

Coaxial cables are frequently used in the transmission of audio and video signals, such as in the cable television industry, and as interconnects between electronic components. Coaxial cable consists of a center core wire surrounded by a dielectric insulator which is further wrapped in flexible metal shielding. A final layer of plastic jacket surrounds the metal shielding.

Termination of the coaxial cable is often performed by applying a compression fitting, such as a THOMAS & BETTS brand SNAP-N-SEAL connector. To attach such a connector, the plastic jacket must be removed to expose metal shielding, and a portion of the metal shielding and dielectric insulator closer to the end of the coaxial cable must further be removed to leave a section of exposed center core wire. A compression fitting is then installed on the end using a crimping tool. One such tool for stripping the wire and applying the compression fitting is the THOMAS & BETTS brand IT1000 connector installation tool. This tool has dual blades that allow simultaneous removal of the plastic jacket near the end of the wire, as well as the plastic jacket, metal shielding, and dielectric insulator further from the end of the wire.

However, in prior art cable stripping tools, the area between the blades frequently got clogged with a portion of the plastic jacket removed from the cable. Since the operator of the tool most likely uses one hand to hold the coaxial cable and the other to hold the tool, removal of that discarded plastic jacket portion was particularly difficult without releasing the coaxial cable and using a small tool to dislodge it. In difficult cable installation areas, such as on utility pole-mounted cables, removal of the scrap material in order to use the stripping tool was particularly difficult.

### SUMMARY OF THE INVENTION

An improved cable stripping and crimping tool is disclosed that overcomes the problem of discarded scrap material becoming lodged between stripping blades. The disclosed tool includes an ejector pin that easily allows removal of the discarded material from between the blades by pressing a button.

### BRIEF DESCRIPTION OF THE DRAWINGS

Further advantages of the invention will become apparent by reference to the detailed description of preferred embodiments when considered in conjunction with the drawings:

FIG. 1 depicts a perspective view of the coaxial cable tool as viewed from the rear and left of the device.

FIG. 2 depicts a second perspective view of the coaxial cable tool as viewed from the rear and right of the device.

FIG. 3 depicts a left side view of the coaxial cable tool.

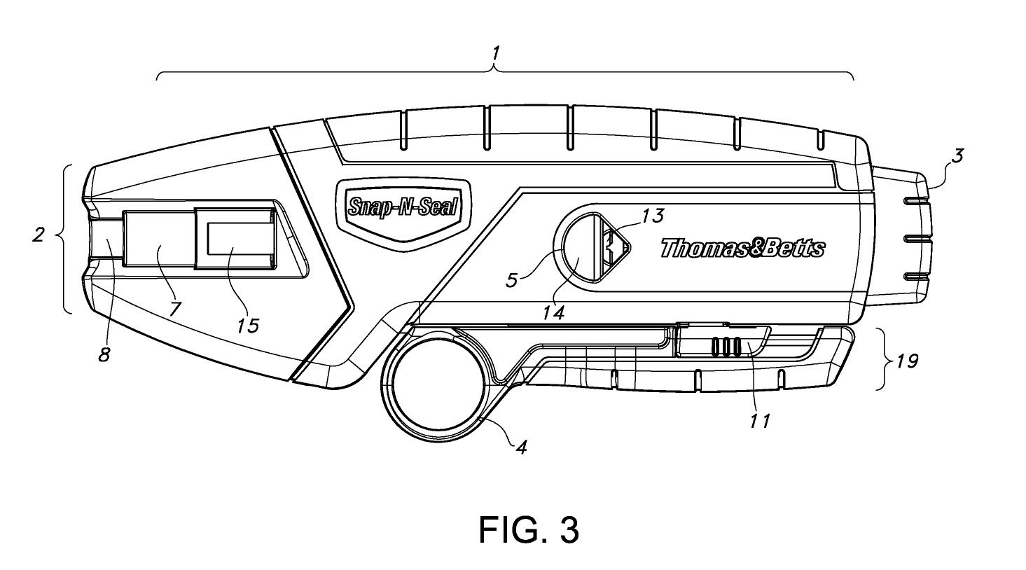

FIG. 4 depicts a right side view of the coaxial cable tool.

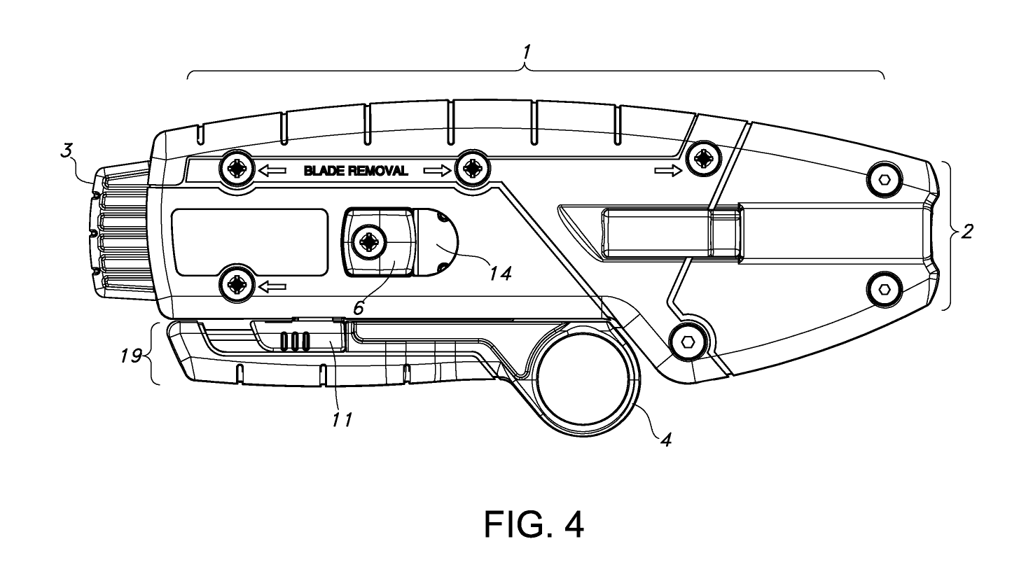

FIG. 5 is an exploded view of the coaxial cable tool.

FIG. 6 depicts the coaxial cable tool showing the internal components as viewed from the left side of the device.

FIG. 7 depicts the coaxial cable tool showing the internal components as viewed from the right side of the device.

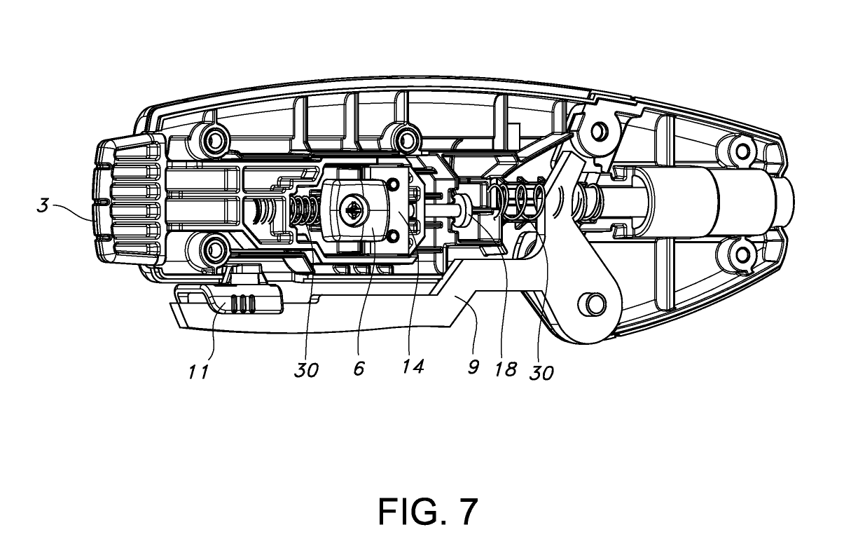

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

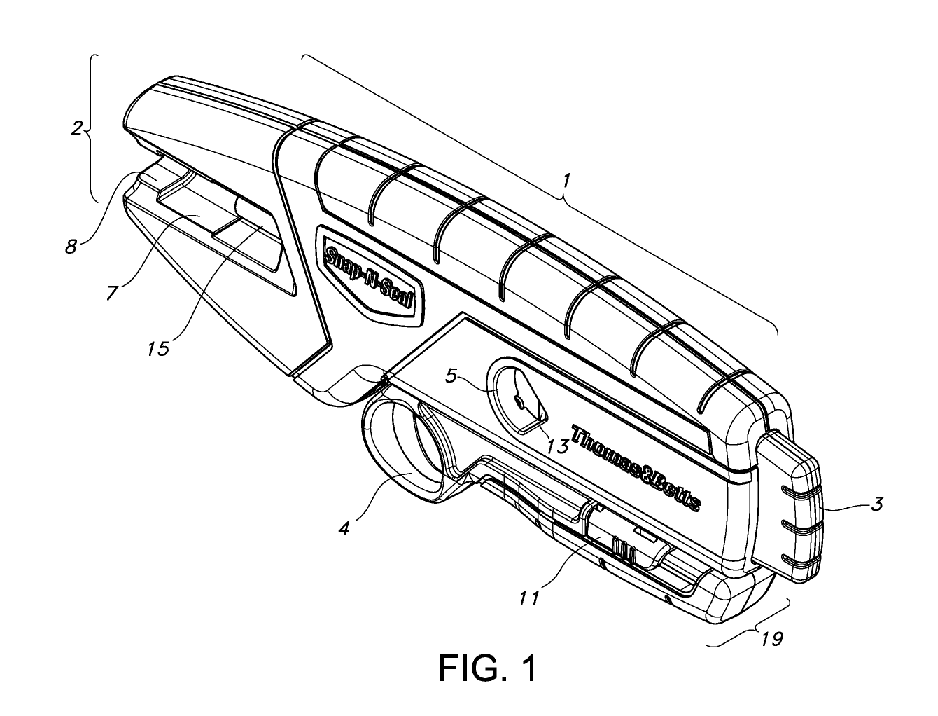

Referring to the drawings, FIG. 1. illustrates an exemplary embodiment of the coaxial cable stripper having an elongated body 1 with one end having a nose 2, and the other end having a scrap ejector button 3. The primary purpose of the nose end of the tool is for crimping connectors to the coaxial cable. The nose 2 is configured to accept a cable connector into a recessed area accessible from one side of the body called the connector seating 7. The cable connector is prevented from sliding out of the nose end of the body 1 by a raised lip referred to herein as the connector retainer 8.

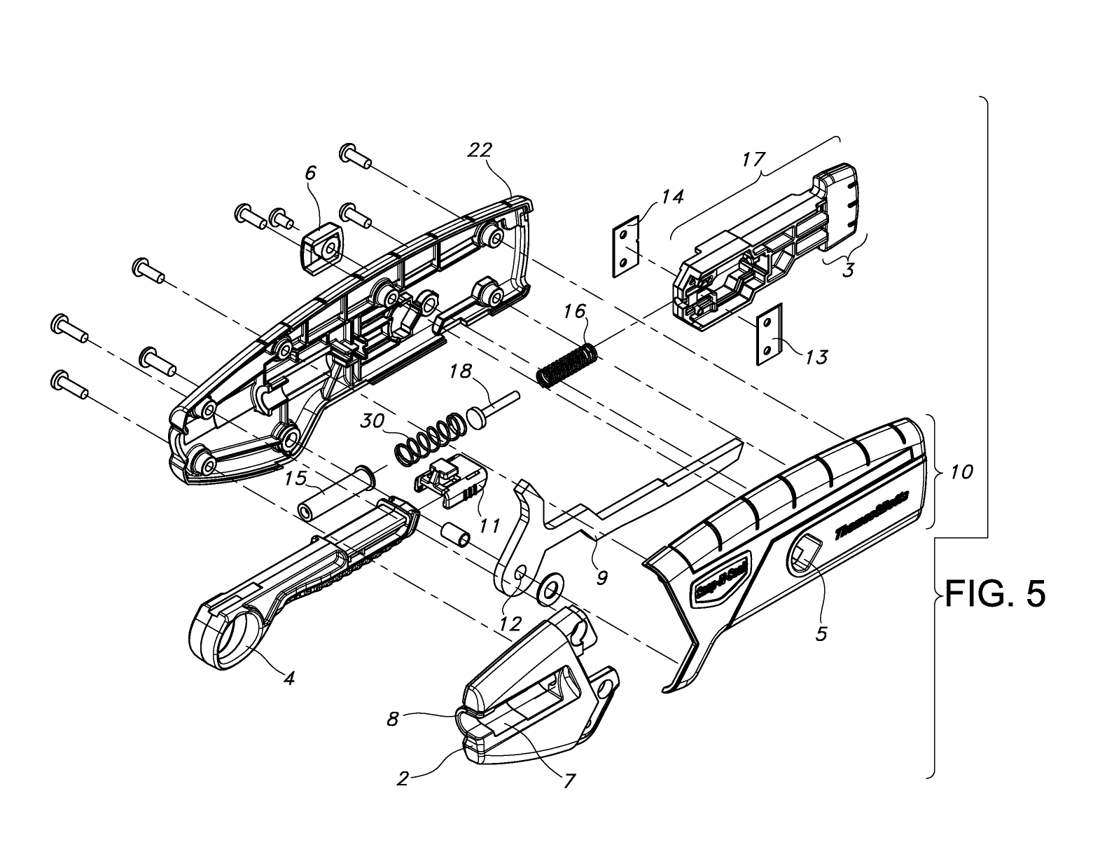

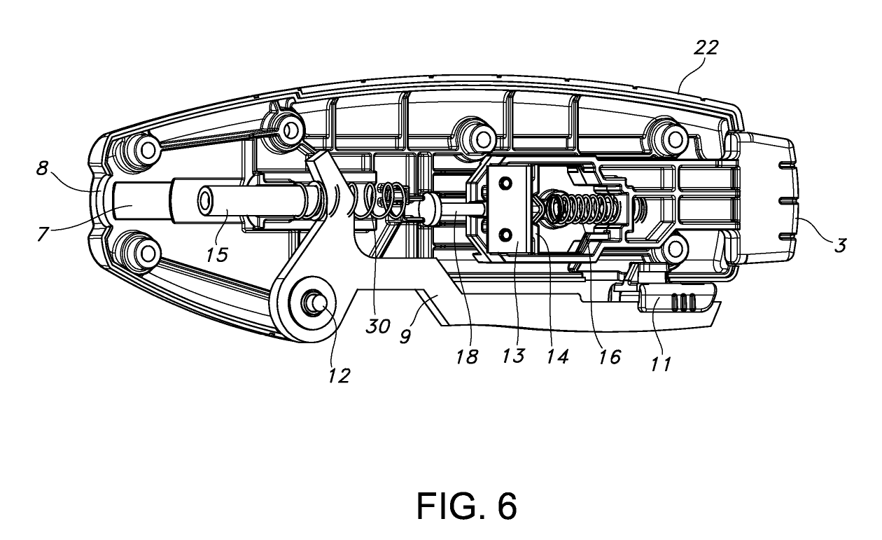

The cable is stripped at the blade carrier end of the tool. As will be appreciated by FIG. 6, blade carrier 17 is slidably mounted relative to casing 22 of the tool. Blade carrier spring 16 pushes blade carrier 17 toward scrap ejector button 3. Opening 5 is configured to receive the end of a coaxial cable that will be terminated with a connector. In the tool's normal state, the opening 5 is blocked from receiving a coaxial cable by cable stripping blades 13 and 14, which are mounted directly on blade carrier 17. As can be seen from FIG. 5, cable stripping straight blade 13 and cable stripping notched blade 14 are parallel to each other, but have slightly different shapes. Cable stripping notched blade 14 has a mostly straight edge with a notch that can accommodate the center core wire of the cable. It is intended to cut all but the center core wire of the coaxial cable. Cable stripping straight blade 13 has a straight edge without a notch, and, when mounted on blade carrier 3, does not extend as far away from the nose end of the body 1 as cable stripping notched blade 14. Cable stripping blade 13 is suitable for cutting into the jacket of the cable without cutting into the metal shielding of the cable.

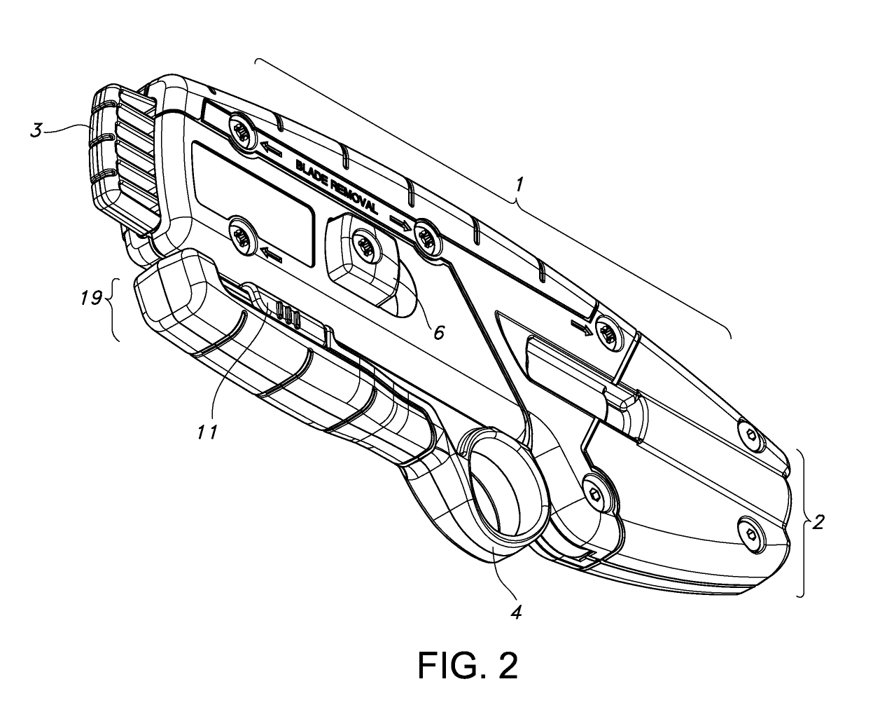

Depressing scrap ejector button 3 toward nose 2 causes the cable stripping blades 13 and 14 to move toward nose 2, thus allowing the coaxial cable to pass through the opening 5. As can be seen from FIG. 2, the coaxial cable's passage through the body 1 is impeded by cable stop 6 located on the opposite side of body 1 as the opening 5. Cable stop 6 allows the end of the coaxial cable to be properly positioned relative to cable stripping blades 13 and 14 so that the proper amount of cable material will be stripped away.

To strip the coaxial cable, the scrap ejector button 3 is depressed toward nose 2 of the tool, causing the cable stripping blades 13 and 14 to move toward nose 2 of the tool. The cable is then inserted into opening 5 until it touches cable stop 6. The scrap ejector button 3 is then released, and blade carrier spring 16 causes cable stripping blades 13 and 14 to exert force against the coaxial cable. The tool is then rotated about the axis of coaxial cable, causing the blades to cut into the cable. Rotation of the tool about the cable is facilitated by molded grip 4 which allows the operator to insert a finger or thumb into it for easy maneuvering of the tool. Cable stripping notched blade 14 will cut into all layers of the cable down to the center core wire. Cable stripping straight blade 13 will cut only into the plastic jacket.

When the blades have cut sufficiently far into the cable, the cable is then pulled away from the tool. Cable stripping notched blade 14 will shear all layers of the coaxial cable that surround the central core wire away from the end of the cable. This discarded material will fall away toward the cable stop 6 and can exit the tool through an opening in cable stop 6. Cable stripping straight blade 13 will shear away only the plastic jacket of the cable. However, this discarded portion of the jacket will remain lodged in the area between cable stripping straight blade 13 and cable stripping notched blade 14.

The design of the tool allows the jacket scrap to be ejected simply by depressing the scrap ejector button 3. As can be seen from FIG. 5 and FIG. 6, an ejector pin 18 is positioned within casing 22 of the tool such that the tip end, which is closest to the opening 5, rests between cable stripping straight blade 13 and cable stripping notched blade 14. In a preferred embodiment, the ejector pin 18 is secured at the end near nose 2 by grooves in casing 22 of the tool. The ejector pin 18 serves to remove the discarded jacket material that gets caught between the cable stripping straight blade 13 and the cable stripping notched blade 14. The ejector pin 18 is of sufficient length that the tip extends just beyond the nose-end edge of opening 5. As the scrap ejector button 3 is depressed, cable stripping notched blade 14 and cable stripping straight blade 13 move toward the nose 2 of the tool just beyond the tip of ejector pin 18. Any jacket scrap that remains between the two blades is pushed out by the tip of the ejector pin 18 and can fall out of the tool through opening 5.

It should be appreciated that only one hand is required to operate the tool. This is particularly helpful in situations where the operator needs to hold on to the cable to prevent it from dropping, for example when on a ladder or when working at the top of a utility pole. The tool can be fully used with the coaxial cable in one hand and the tool in the other. Positioning the cable in the opening 5, depressing scrap ejector button 3, rotating the tool about the coaxial cable, and ejecting the discarded jacket material can all be performed with one hand. Similarly, crimping the connector to the end of the cable can be performed with just one hand on the tool, and the other on the coaxial cable.

Once the cable end has been stripped, the tool can be used to crimp a connector onto the coaxial cable. Crimping is performed through the action of crimping pin 15 pushing a compression connector against connector retainer 8, thus, sealing it against the cable. Crimping pin 15 is positioned within a groove of casing 22 such that it can slide toward the nose-end of the tool. As can be seen from FIG. 5 and FIG. 6, lever 9 is located such that it pivots about pivot point 12. Lever 9 has a handle end, located within molded grip 4, and a nose-end that is configured to apply pressure against crimping pin 15. Crimping pin 15 is coupled to the nose-end arm of lever 9 such that the nose-end arm of lever 9 and crimping pin 15 move together toward the nose-end of the tool when the handle end of lever 9 is squeezed toward the body of the tool. Both the nose-end of lever 9 and crimping pin 15 are coupled to casing 22 through the use of crimping pin spring 20. The crimping pin spring 20 keeps the crimping pin 15 in a retracted state away from the nose-end of the tool, facilitating insertion of a connector into the connector seating 7. Due to the force of crimping pin spring 20 pulling nose-end of lever 9 to achieve lowest spring tension, the handle-end of the lever 9 is pushed away from the body of the tool as it pivots about pivot point 12. As a result, the handle assembly 19 sticks out from the body of the tool in the state of lowest spring tension of crimping pin spring 20.

For compact storage of the tool, the handle assembly 19 can be secured against the body of the tool through the use of handle latch 11. Handle latch 11 is slidably coupled to molded grip 4 and is configured to engage a catch on casing 22 of body 1. To lock the tool, the handle assembly 19 is squeezed in toward the body 1, and the handle latch 11 is slid toward the catch on the body 1. Alternatively, a wire bail on handle assembly 19 that snags a portion of the body 1 may be employed to secure the handle assembly 19 against the body 1 of the tool.

An additional feature of the design of the tool is that the cable stripping blades 13 and 14 may easily be replaced as required. To replace the blades, screws which hold cover 10 of the tool to casing 22 are removed. Cover 10 is then lifted off, and the blade carrier 3 is removed from the channel in the casing 22 in which it sits, along with blades that are attached to it. After the cable stripping blades 13 and 14 are replaced, the blade carrier 17 can be reinserted into its grooves in the casing 22, and the cover 10 screwed back on.

The casing 22, cover 10, and blade carrier 17 are preferably made of molded plastic which makes the tool light and inexpensive. However, the tool can also be made of cast metal or any other rigid material. It should be appreciated that in a preferred embodiment, the body 1 can be ergonomically shaped and include a textured surface to reduce the likelihood of the tool slipping out of the hand.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A device for preparing a coaxial cable for receiving a compression-fit connector comprising:
a. a body having an opening through which a coaxial cable may be inserted;
b. a stripping mechanism comprising parallel blades positioned to cut into said coaxial cable at different depths; and
c. an ejector for removing stripped cable jacket from between said parallel blades, wherein said parallel blades move relative to said ejector for removing stripped cable jacket.

2. The device of claim 1 further comprising a cable stop that limits the distance to which coaxial cable may be inserted.

3. The device of claim 2 wherein said cable stop has an opening for the removal of stripped cable jacket.

4. The device of claim 1 further comprising a mechanism for crimping a coaxial connector onto said coaxial cable.

5. The device of claim 1 wherein said parallel blades are mounted on a carrier capable of sliding relative to said body such that movement of the carrier causes said parallel blades to slide past said opening of said body.

6. The device of claim 1 wherein said parallel blades may be replaced.

7. A device for attaching a compression-fit connector to a coaxial cable comprising:
a. a body having an opening through which a coaxial cable may be inserted;
b. a stripping mechanism comprising parallel blades positioned to cut into said coaxial cable at different depths,
c. an ejector for removing stripped cable jacket from between said parallel blades, wherein said blades move relative to said ejector for removal of said stripped cable jacket; and
d. a compression mechanism for securing said compression-fit connector to a coaxial cable.

8. The device of claim 7 further comprising a cable stop that limits the distance that said coaxial cable may be inserted.

9. The device of claim 8 wherein said cable stop has an opening for the release of stripped cable jacket.

10. The device of claim 7 wherein said parallel blades are mounted on a carrier capable of sliding relative to said body such that movement of the carrier causes said parallel blades to slide past said opening of said body.

11. The device of claim 7 wherein the carrier moves said blades relative to said ejector.

12. The device of claim 7 further comprising a locking handle to retain a handle against said body.

13. The device of claim 12 wherein said locking handle locks by means of a slidable catch.

14. The device of claim 12 wherein said locking handle locks by action of a wire bail.

15. The device of claim 7 wherein the body is comprised of molded plastic.

16. The device of claim 7 wherein said parallel blades may be replaced.

17. A device for stripping cable jacket from a coaxial cable comprising:
a. parallel blades;
b. a spring that cause said parallel blades to apply pressure to cut said cable jacket; and
c. an ejector for removing the cut cable jacket from between said parallel blades.

18. The device of claim 17 wherein said ejector ejects cut cable jacket when said parallel blades are moved in the direction opposite of the spring force.

19. The device of claim 17 further comprising a mechanism for connecting a cable connector to said cable.

20. The device of claim 17 further comprising a locking mechanism to retain handle against the body of said device.
